(19) United States
(12) Patent Application Publication
(10) Pub. No.: US 2007/0083901 A1
(43) Pub. Date: Apr. 12, 2007

(54) System and method for customized program scheduling

(76) Inventor: Madison E. Bond, Philadelphia, PA (US)

Correspondence Address: BROOKS KUSHMAN P.C., 1000 TOWN CENTER, TWENTY-SECOND FLOOR, SOUTHFIELD, MI, 48075, US

(21) Appl. No.: 11/248,403

(22) Filed: Oct. 12, 2005

(51) Int. Cl. H04N 7/173; H04N 7/16

(52) U.S. Cl. 725/94; 725/90; 725/134; 725/142

(57) ABSTRACT

The present invention provides a user improved flexibility and convenience in selecting and receiving programming content utilizing a VOD or switched video architecture. Accordingly, the invention includes a system and method of delivering a linear programming feed to a user wherein the programming feed is initially transmitted from a transmission source. The method includes storing the transmitted programming feed in a memory buffer on a server and delivering the feed stored in the buffer to the user in on a designated channel. The method also includes refreshing the buffer when a buffer refreshing period has occurred. Additionally, the method includes determining whether the user has entered a command and executing the command entered by the user. The method further includes identifying time cues associated with the programming feed and delivering the programming feed in accordance with the time cues.

### TECHNICAL FIELD

The present invention relates generally to a system and method for delivering a customized linear programming feed to a user.

The conventional video-on-demand (VOD) system enables users to select programming content from a server for viewing and/or listening on a television or a computer. The services related to the VOD technology are typically provided over a bi-directional digital medium such as an asymmetric digital subscriber line (ADSL) system or a digital cable system. Typically, VOD services are received by the user through the use of a set-top box (STB) connected to the user's television or computer. The STB is an electronic device that enables the user to order and view selected programs at a time of their choosing. Although the services associated with the conventional VOD system provide some flexibility in selecting and receiving programming, the conventional systems have several disadvantages. For instance, the conventional systems provide a limited number of programs from which to choose. Secondly, selected programs must be viewed within a limited window of time. Additionally, users are required to separately select a program on each occasion the user desires to view the program.

The present invention was conceived in view of these and other disadvantages of the prior art.

### SUMMARY

The present invention provides a user improved flexibility and convenience in selecting and receiving programming content (also referred to as a programming feed) utilizing a VOD or switched video architecture. Accordingly, the invention includes a method of delivering a linear programming feed to a user wherein the programming feed is initially transmitted from a transmission source. The method includes storing the transmitted programming feed in a memory buffer on a server and delivering the feed stored in the buffer to the user in substantially real-time on a designated channel. The method also includes refreshing the buffer when a buffer refreshing period has occurred. Additionally, the method includes determining whether the user has entered a command and executing the command entered by the user. The method further includes identifying time cues associated with the programming feed.

The present invention further discloses a system for delivering a linear programming feed to a user wherein the programming feed is initially transmitted from a transmission source. The system is configured to store the transmitted programming feed in a memory buffer on a server and determine whether a buffer refreshing period has occurred. The system is further configured to deliver the feed stored in the buffer to the user in substantially real-time on a designated channel and refresh the buffer when the buffer refreshing period has occurred. The system is also configured to identify time cues associated with the programming feed and deliver the feed to the user based on the time cues.

Moreover, the present invention discloses a method of delivering a linear programming feed to a user that includes inputting a command to create a viewing schedule and selecting scheduled or non-scheduled programming. The method includes storing the selected programming in a memory buffer on a server based on the viewing schedule. The method also includes integrating the stored programming to create a linear programming feed based on the viewing schedule and delivering the linear programming feed to the user on a designated channel in accordance with the viewing schedule.

### BRIEF DESCRIPTION OF THE DRAWINGS

These and other features and advantages of the invention will be apparent from the following detailed description and the appendant claims, taken in conjunction with the accompanying drawings, in which:

FIG. 1 illustrates a communications system capable of providing video-on-demand (VOD) services that enables a user to customize program scheduling; and

FIGS. 2-4 illustrate flow diagrams for delivering a customized linear programming feed to a user through the use of the communications system of FIG. 1.

### DETAILED DESCRIPTION OF THE PREFERRED EMBODIMENT(S)

By way of example, a system and methodology for implementing the present invention is described below. The provided system and methodology may be adapted, modified or rearranged to best-fit a particular implementation of the present invention.

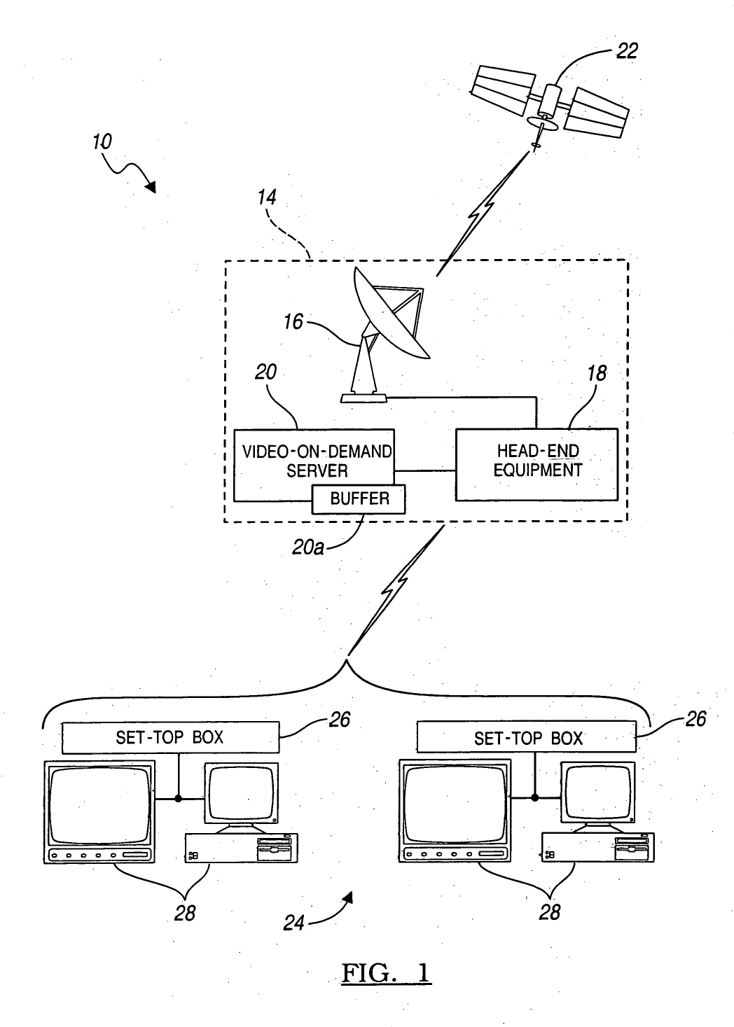

Referring to FIG. 1, a communications system 10 is illustrated that enables a user, distributor, or content supplier to deliver and/or receive customized programming content. The programming content may include video, audio, and/or data content. Communications system 10 is adapted to provide a “virtual” channel that may utilize video-on-demand (VOD) or a switched video architecture to deliver programming in a customizable and scheduled fashion. In one aspect, a distributor may use the virtual channel to conserve bandwidth while providing enhanced functionality for the user. Additionally, communications system 10 enables a user (i.e., a customer) to customize the channel based on user preferences and/or viewing behavior.

Communications system 10 includes a cable office 14 and a user network 24. Cable office 14 is adapted to receive live programming feeds containing the audio, video and/or data content from a transmission source 22 (e.g. a satellite) and deliver a linear programming feed to user network 24. Cable office 14 includes a signal receiver 16, head-end equipment 18, and a VOD server 20. Signal receiver 16 initially receives a transmitted programming feed from transmission source 22. In the embodiment shown, signal receiver 16 is a conventional satellite dish. It is recognized however, that signal receiver 16 may be any receiver or device capable of receiving a programming feed from transmission source 22. Signal receiver 16 is communicative with head-end equipment 18. Head-end equipment 18 formats and organizes the programming feeds for delivery to user network 24. As such, the head-end 18 is configured to receive programming from various sources, assign the programming to channels including the virtual channel(s) described herein, and retransmit the programming to the user network 24 via VOD server 20. VOD server 20 includes a buffer 20a that is adapted to store the programming feed being routed through head-end equipment 18. In one aspect, to enhance system performance, buffer 20a temporarily stores the programming feed for a predetermined period and is refreshed thereafter (referred to as a buffer refreshing). VOD server 20 is also configured to receive commands from a user and execute those commands accordingly. In particular, the user may, through the use of VOD server 20, pause, rewind, fast-forward, record and stop the programming feed as it is being delivered to user network 24. VOD server 20 may also perform functions such as admission control, request handling, data retrieval, video/audio stream transmission, and video/audio stream encryption.

In one embodiment, cable office 14 identifies time cues associated With the programming feed. The time cues denote when scheduled programming is to be delivered to the user. Cable office 14 is further configured to enable the user to create a viewing schedule that may include real-time/scheduled programming with non-scheduled programming. Accordingly, VOD server 20 is capable of integrating the real-time/scheduled and non-scheduled programming in accordance with the viewing schedule.

User network 24 includes a set-top box that is capable of decoding encrypted signals from cable office 14 and interfacing with receiving devices 28 to display/play the programming feed for the user. In the embodiments shown, receiving devices 28 are illustrated as a television and a computer. It is recognized, however, that receiving device 28 may be any device capable of interfacing with the set-top box 26 such as a personal digital assistant (PDA) or a cellular telephone. As shown, user network 24 includes multiple set-top boxes 26 and receiving devices 28. Accordingly, cable office 14 is capable of servicing virtually any number of set-top boxes 26 and receiving devices 28. Set-top box 26 and receiving device 28 may be located in the user's home, business, or any location in which services from cable office 14 are desired. Thus, user network 24 may be populated throughout any residential and/or business community.

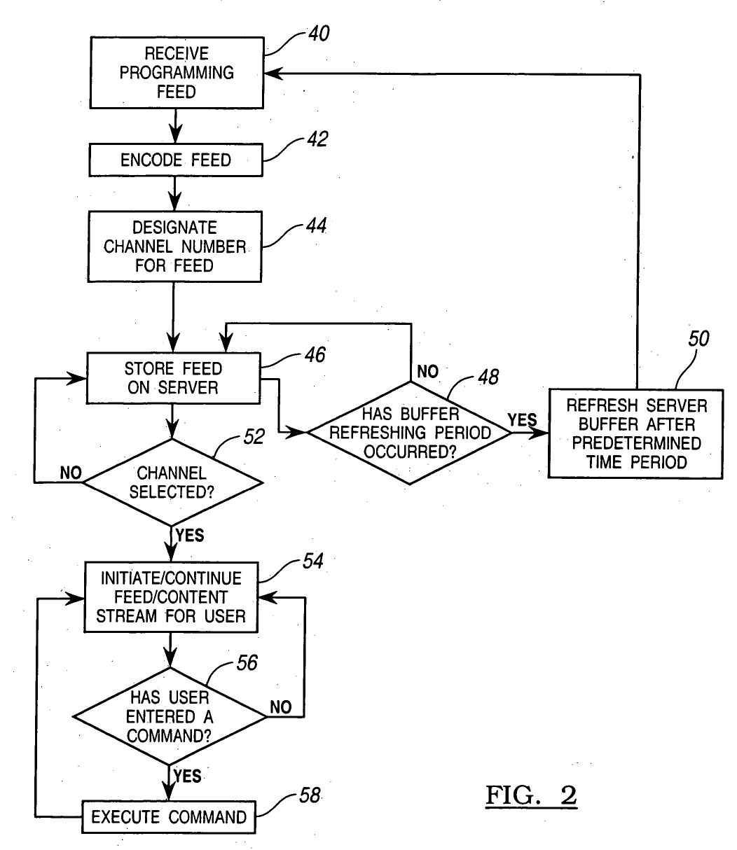

Referring to FIG. 2, a flow diagram is illustrated that enables delivery of a linear programming feed in a customized and efficient manner. Accordingly, at step 40, the programming feed is received at cable office 14, from transmission source 22. As discussed above, the transmission source 22 may be an orbiting satellite. In an alternative embodiment, the transmission source may be another cable office or programming distribution facility. At a step 42, the programming feed content may be encoded through the use of head-end equipment 18 and VOD server 20. Encoding of the programming feed content diminishes the possibility of unauthorized reception and/or piracy of the programming feed. In an alternative embodiment, the programming feed content may be encoded as transmitted by the transmission source 22.

At a step 44, the virtual channel is created wherein a channel number is designated through the use of head-end equipment 18 that is accessible by the user for viewing of the programming feed content. At a step 46, the programming feed content is stored on VOD server 20 through the use of buffer 20a. In one aspect of the invention, the user, through the use of set-top box 26, may cause the storage of the programming feed content or portions thereof by inputting a record command to the set-top box 26. In another embodiment, storage of the programming feed content may occur as determined by cable office 14 or a programming content supplier. As discussed in the foregoing, buffer 20a may be configured to temporarily store the programming feed for a predetermined time period. Once the predetermined time period has occurred, the buffer will be refreshed by erasing/deleting the stored programming feed. Hereinafter, the time from which the buffer stores the programming feed until the time in which the buffer is refreshed will be referred to as the buffer refreshing period.

Accordingly, at a step 48 the VOD server 20 determines whether the buffer refreshing period has occurred. In one embodiment, the buffer refreshing period is about two hours but may be increased or decreased depending on system design and performance requirements. When the buffer refreshing period has occurred, the buffer is refreshed which is illustrated at a step 50. In one aspect, refreshing the buffer 20a enables optimized system performance, particularly when the memory space of buffer 20a is less than optimal. Following step 50, a step 40 occurs where additional programming feed content is received. When the buffer refreshing period has not occurred, the flow diagram returns to step 46 where the programming feed is stored on VOD server 20.

As discussed in the foregoing, head-end equipment 18 is configured to designate a channel number for the programming feed. As such, at a step 52 the method determines whether the designated channel number has been selected. If the a designated channel has not been selected, the method returns to step 46. When the designated channel has been selected, a step 54 occurs, wherein the programming feed is streamed to set-top box 26 for viewing by the user through the use of receiving devices 28. At step 56, the system determines whether the user has entered a command through the use of set-top box 26. For example, set-top box 26 enables the user to play, rewind, fast-forward, and/or record the programming feed. If the user has not entered a command, the method returns to step 54 and continues to stream the programming feed content to the user. When the user enters a command, a step 58 occurs wherein the entered command is executed through the use of set-top box 26 and VOD server 20. The flow diagram illustrated in FIG. 2 provides a method of delivering a linear programming feed by encoding and storing the programming feed. The programming feed may be stored in a continuously refreshing buffer 20a that is integrated with the VOD server 20. Once the user selects the designated channel in which the programming feed is accessible, the user may enter commands that modify delivery of the streaming content. Accordingly, the programming feed that is ultimately delivered to the user may be delivered in real-time or as dictated by the user.

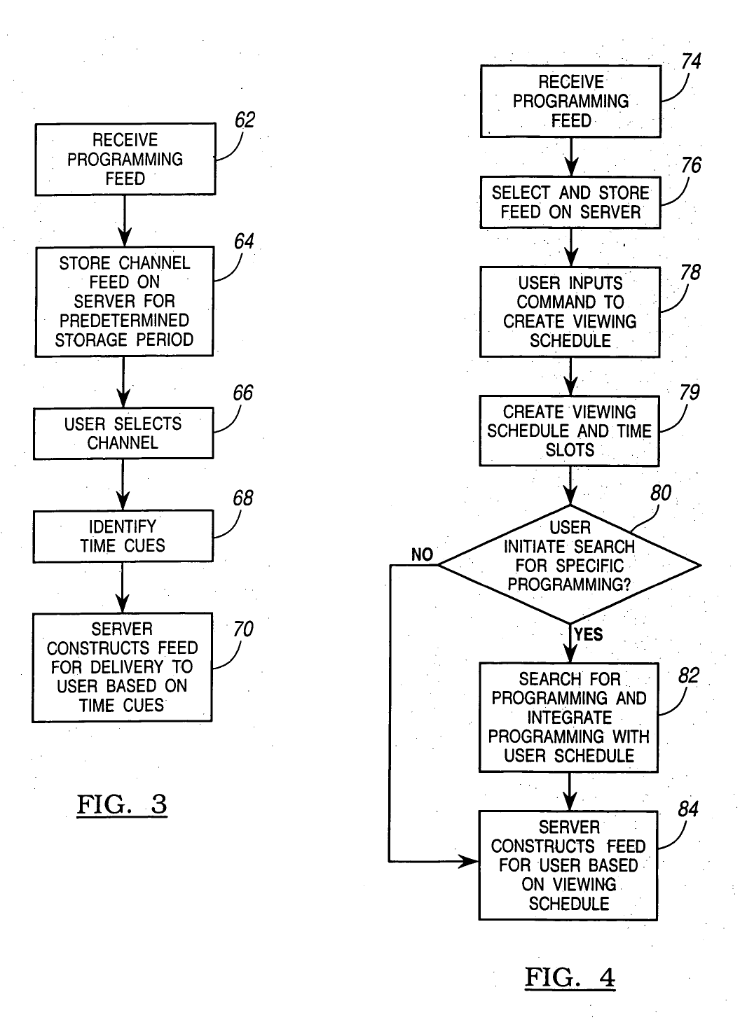

Referring to FIG. 3, a flow diagram is illustrated that provides an alternative method for customizing the user's viewing experience. In one aspect of the invention, the method illustrated in FIG. 3 may be utilized by a cable office that does not rely on an exclusive or substantial supply of continuous live programming feeds. As such, the methodology enables the storage of all or substantially all programming content required for the designated channel through the use of VOD server 20. In this embodiment, the VOD server 20 contains a sufficient amount of memory so as to store the programming requirements of the channel. The method can further allow the stored programming content to be assessed by the user in a fashion that emulates a linear channel, with VOD server 20 constructing a programming feed that is delivered to user network 24 based on time cues associated with the programming.

At a step 62, the method receives the programming feed that may originate from transmission source 22. However, as described above, the designated channel may not rely exclusively on a continuous live programming feed from transmission source 22. As such, at a step 64, the programming content for the designated channel is stored on VOD server 20 for a predetermined storage period. Depending upon the user and system requirements, the predetermined storage period may be 2-24 hours. Once the predetermined storage period has occurred, cable office 14 may generate a signal requesting an additional programming feed for storage. As stated above, VOD server 20 contains sufficient memory to store the programming requirements of the channel such that a continuous programming feed from transmission source 22 is not required. At a step 66, the user selects the channel number designated for the stored programming feed.

Additionally, as discussed above, the methodology enables VOD server 20 to construct a feed for delivery to user network 24 based on time cues associated with the stored programming period. The program delivery via VOD server 20 emulates a linear programming feed. Moreover, VOD server 20 functions enable the user to access the stored content on the designated channel based on the time cues. In particular, the stored programming feed may be delivered to the user at a predetermined time period associated with the time cue, which in one embodiment may be the beginning of a scheduled program (e.g., a movie).

For example, a program may have a time cue of 8:00 p.m. on the designated channel. However, a user tunes in to the designated channel at say, 8:14 p.m. In such a case, through the use of set-top box 26 and VOD server 20, the user may be automatically directed to the beginning of the program, although the program was originally designated to begin at 8:00 o'clock p.m. As such, at a step 68, time cues associated with the stored programming are identified. At a step 70, the server constructs the programming feed for delivery to the user based on the identified time cues.

Referring to FIG. 4, a flow diagram is illustrated that enables a user to further customize and enhance his/her viewing experience by creating a viewing schedule. According to this embodiment, the user may schedule programming for viewing during a time when the program is originally scheduled to play (i.e., real-time) and/or schedule non-scheduled programming. The user may also create a viewing schedule that is comprised of either consecutive or non-consecutive time slots. For example, the viewing schedule may include programming that is available from 3:00 p.m. to 5:00 p.m. and have no programming scheduled between 5:00 p.m. and 6:00 p.m.

As illustrated in FIG. 4, at a step 74, a programming feed is received. At a step 76, the programming feed content selected by the user is stored on VOD server 20. At a step 78, the user inputs a command to create a viewing schedule. At a step 79, the user creates the viewing schedule by selecting programs of interest and specifying times in which the programs will play. The user may utilize set-top box 26, which communicates with VOD server 20 to create the viewing schedule. Accordingly, at a step 80 the user initiates a search for specific programming of interest. In particular, the user may initiate a search for sports or home improvement programs and designate times for viewing. For example, the user may wish to create a viewing schedule that allows him/her to watch that day's 6:00 p.m. news at 8:00 p.m. and watch a particular sitcom episode originally scheduled for 9:00 p.m., at 9:00 p.m. As such, pursuant to the methodology of FIG. 4, the user may create a schedule that provides for real-time programming feeds that are shown during their regularly scheduled time slot and/or non-real-time programming feeds that are shown during a user-designated time slot. Accordingly, the system is capable of integrating the real-time scheduled programming feeds with non-scheduled programming feeds for an enhanced and customized viewing experience. At a step 82, through the use of set-top box 26 and VOD server 20, the user may search for programming and integrate the programming in accordance with the viewing schedule. Additionally, the user may initiate a search for programming related to a predetermined topic wherein these programs may be integrated with the viewing schedule. Accordingly, at a step 84, the server constructs the programming feed for the user in accordance with the viewing schedule.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of delivering a linear programming feed to a user wherein the programming feed is initially transmitted from a transmission source, the method comprising:
storing the transmitted programming feed in a memory buffer on a server;
delivering the feed stored in the buffer to the user on a designated channel; and
refreshing the buffer when a buffer refreshing period has occurred.

2. A method according to claim 1, further comprising:
determining whether the user has entered a command; and
executing the command entered by the user.

3. A method according to claim 1, further including identifying time cues associated with the programming feed.

4. A method according to claim 1, wherein delivering the feed to the user includes delivering the feed to the user based on time cues.

5. A method according to claim 4, wherein delivering the feed to the user based on time cues further includes automatically delivering the feed so as to deliver the feed at a beginning of a predetermined time period associated with the time cue.

6. A method according to claim 5, wherein the beginning of the predetermined time period includes the beginning of a program that is designated to play.

7. A method according to claim 1, further including encoding the transmitted programming feed.

8. A method according to claim 1, wherein the buffer refreshing period is about 2 hours.

9. A method according to claim 1, wherein storing the live programming feed in a memory buffer on a server includes a memory buffer on a video-on-demand server.

10. A method of delivering a linear programming feed to a user comprising:
inputting a command to create a viewing schedule;
selecting scheduled or non-scheduled programming;
storing the selected programming in a memory buffer on a server based on the viewing schedule;
integrating the stored programming to create a linear programming feed based on the viewing schedule; and
delivering the linear programming feed to the user on a designated channel in accordance with the viewing schedule.

11. A method according to claim 10, wherein creating the viewing schedule includes searching for programming related to a predetermined topic.

12. A method according to claim 10, further including encoding the live programming feed.

13. A method according to claim 10, wherein creating a viewing schedule includes a viewing schedule having consecutive or non-consecutive programming time slots.

14. A method according to claim 10, further including selecting time slots for the selected programming.

15. A method according to claim 10, wherein storing the scheduled and non-scheduled programming feed in a memory buffer on a server includes a video-on-demand server.

16. A communications system for delivering a linear programming feed to a user wherein the programming feed is initially transmitted from a transmission source, the system being configured to:
store the transmitted programming feed in a memory buffer on a server;
determine whether a buffer refreshing period has occurred;
deliver the feed stored in the buffer to the user on a designated channel; and
refresh the buffer when the buffer refreshing period has occurred.

17. A system according to claim 16, wherein the system is further configured to:
determine whether the user has entered a command; and
execute the command entered by the user.

18. A system according to claim 16, wherein the system is further configured to identify time cues associated with the programming feed.

19. A system according to claim 16, wherein the system being configured to deliver the feed to the user further includes the system being configured to deliver the feed to the user based on at least the time cues.

20. A system according to claim 19, wherein the system being configured to deliver the feed to the user based on at least the time cues further includes the system being configured to automatically deliver the feed at a beginning of a predetermined time period associated with the time cue.

21. A system according to claim 20, wherein the system being configured to deliver the feed at the beginning of the predetermined time period includes delivering the feed at the beginning of a program that is designated to play.

22. A system according to claim 16, wherein the system is further configured to encode the feed.

23. A system according to claim 16, wherein the buffer refreshing period is about 2 hours.

24. A system according to claim 16, wherein the system is configured to store the programming feed in a memory buffer on a server includes storing the programming feed in a memory buffer on a video-on-demand server.

25. A method of delivering a linear programming feed to a user comprising:
storing a transmitted programming feed in a memory buffer on a video-on-demand server for a predetermined storage period;
determining whether a buffer refreshing period has occurred;
delivering the stored programming feed through the use of a set-top-box to a designated channel, wherein the designated channel does not rely exclusively on a continuous programming feed; and
refreshing the buffer when a buffer refreshing period has occurred.

26. A method according to claim 25, further including:
identifying time cues associated with the stored programming feed; and
delivering the stored programming feed through the use of the set-top-box to a designated channel based on the time cues, wherein the designated channel does not rely on a continuous programming feed.

27. A method according to claim 25, further including:
creating a viewing schedule for the stored programming feed; and
delivering the stored programming feed in accordance with the viewing schedule.

28. A method according to claim 25, wherein the predetermined 2 storage period is in a range of 2-24 hours.
